(19) United States
(12) Patent Application Publication
(10) Pub. No.: US 2012/0013582 A1
(43) Pub. Date: Jan. 19, 2012

(54) IMAGE DISPLAY APPARATUS

(75) Inventors: Yukihiro Inoue, Yokohama-shi (JP); Tomoya Onishi, Ayase-shi (JP)

(73) Assignee: CANON KABUSHIKI KAISHA, Tokyo (JP)

(21) Appl. No.: 13/158,548

(22) Filed: Jun. 13, 2011

(30) Foreign Application Priority Data
Jul. 13, 2010 (JP) 2010-158618

(51) Int. Cl. G09G 5/00

(52) U.S. Cl. 345/205

(57) ABSTRACT

An image display apparatus comprises a face plate including a common electrode extending in an outside of an image region along a one side of the image region, n first resistor members connected to the common electrode and connected to each of anodes in the divisional regions corresponding thereto, and a second resistor member connecting between one and the other of the first resistor members. R1 is an average resistance value of each first resistor member per length of one pixel including at least one of the light emitting members. R1all is a resistance value of each first resistor member for a total length in the image region. R2 is a resistance value of the second resistor member. And, a relationship of 0.1×R1<R2<R1all is met.

### BACKGROUND OF THE INVENTION

1. Field of the Invention

The present invention relates to an image display apparatus, and specifically relates to a configuration of resistor members provided on a face plate.

2. Description of the Related Art

Conventionally, an image display apparatus including a rear plate on which a plurality of electron-emitting sources are formed and a face plate on which light emitting members that emit light responsive to collision with electrons emitted from the electron-emitting sources and accelerated are formed has been known. In such image display apparatus, the space between the rear plate and the face plate is very small and a high voltage is applied between the rear plate and the face plate for acceleration of the electrons, and causing a problem of what countermeasures to be taken for discharge.

Japanese Patent Application Laid-Open No. 2005-251530 discloses an image display apparatus in which a anode is divided in a row direction. An end of each of the divisional anodes is connected via a resistive element to a common electrode connected to a high voltage source. The other end of each anode is connected to a common resistive element at a position on the side opposite to the common electrode in an outside of the image region.

Japanese Patent Application Laid-Open No. 2006-173094 discloses an image display apparatus in which resistive elements in a grid are formed on a surface of a face plate, and light emitters are provided on the resistive elements. The resistive elements are connected via a resistive element for connection to a common electrode at each of two opposed sides of the face plate.

Japanese Patent Application Laid-Open No. 2004-158232 discloses an image display apparatus including anode electrode units arranged in two dimensions, and resistive elements connecting the anode electrode units. Anode electrode units arranged at an outermost periphery are connected via resistor members to a power supply section surrounding the anode electrode units.

Where a plurality of power supply lines are provided by a resistive element or electrode electrically divided in one direction and a high voltage is applied to the individual power supply lines, countermeasures for discharge can easily be taken because of the enhanced independence of each power supply line. Meanwhile, where one end of each power supply line is terminated in isolation without connection to another power supply line or a common electrode, if a power supply line is disconnected, a high voltage cannot be supplied to the part of the power supply line beyond the disconnected part. Consequently, light emitting members not supplied with the high voltage cannot emit light, resulting in appearance of a dark line, which is a significant image defect. For a countermeasure for such problem, electrically connecting ends of power supply lines resulting from division in one direction on each of opposite sides thereof via resistor members like in Japanese Patent Application Laid-Open No. 2005-251530 is effective as means for lessening the degree of image deterioration caused by a dark line.

However, the present inventors have discovered that simply connecting ends of power supply lines on each of opposite sides thereof via resistor members causes some problems.

Firstly, if resistances of the resistor members connecting the ends of the power supply lines on each of the opposite sides thereof are excessively high, the degree of image deterioration caused by a dark line resulting from line disconnection cannot be lessened. Even where the ends of the power supply lines are connected on each of the opposite sides thereof, if a part whose resistance value is extremely high exits at a position somewhere in the route of the connection, a voltage drop is caused by a current emitted from the rear plate. Here, in the present specification, “emitted current” is used as a term referring to a flow of electrons, and the direction of an emitted current is opposite to the direction of a current in the ordinary sense.

Secondly, where the resistances of the resistor members are excessively high, the potential difference between opposite ends of a relevant resistor member becomes large upon occurrence of a discharge, which may result in destruction of the resistor member. When a discharge occurs between the face plate and the rear plate, a voltage drop occurs in the resistor members according to a current flowing onto the face plate and the resistance values in the route in which the current flows. In such case, if only the resistor members have an extremely high resistance value, the potential difference between the opposite ends of the resistor members becomes large and thus, a secondary discharge may occur, which leads to irreversible deviation of the electrical characteristics of the resistor members from desired characteristics, resulting in image deterioration.

Thirdly, contrarily, if the resistor members have an extremely low resistance value, image quality deterioration called crosstalk or streaking may occur when a particular figure is displayed. Especially, in an FED in which line sequential driving is performed, the direction in which the resistive element is divided into the power supply lines (the direction in which the power supply lines extend) is perpendicular to scanning lines, image quality deterioration easily grows.

An object of the present invention is to provide a highly-reliable image display apparatus that prevents image deterioration resulting from a dark line or streaking while suppressing generation of an abnormal current due to a discharge, and prevents destruction of resistor members.

### SUMMARY OF THE INVENTION

An image display apparatus according to the present invention includes a rear plate wherein a plurality of electron-emitting sources are formed; and a face plate provided with an image region of rectangular shape on which an image is displayed, wherein the image region is divided into n divisional regions by n−1 imaginary lines perpendicular to a one side of the image region, n is a natural number of 2 or more, and each of the divisional region includes a plurality of light emitting member emitting light responsive to a collision with an electron emitted from the electron source and accelerated and a plurality of anode for accelerating the electron, wherein the face plate has a common electrode extending in an outside of the image region along the one side of the image region and supplied with an electricity from a high voltage source, n first resistor members connected to the common electrode, being extended across the image region in a direction perpendicular to the one side of the image region and being connected to each of the anodes of the divisional region corresponding thereto, and a second resistor member arranged in the outside of the image region along the other side of the image region opposite to the one side for connecting one of the first resistor members to the other one of the first resistor members, and wherein R1 is an average resistance value of the first resistor member per a length of one pixel formed by at least one of the light emitting member, R1all is a resistance value of the first resistor member of total length in the image region, R2 is a resistance value of the second resistor member, and a relation 0.1×R1<R2<R1all is met.

According to the present invention, since the condition of R2<R1all is met, even in case that a line disconnection occurs in the first resistive element, an image with no extreme dark line generated can be provided, and furthermore, destruction of the second resistive element is hard to occur upon occurrence of a discharge. Furthermore, since the condition of 0.1×R1<R2 is met, a favorable image with less streaking can be provided.

The present invention enables provision of an image display apparatus that facilitates prevention of image deterioration resulting from a dark line or streaking while suppressing generation of an abnormal current due to a discharge, as well as prevention of destruction of resistor members.

Further features of the present invention will become apparent from the following description of exemplary embodiments with reference to the attached drawings.

### BRIEF DESCRIPTION OF THE DRAWINGS

FIG. 1 is a schematic plan view of a face plate according to the present invention.

FIG. 2 is a schematic cross-sectional view of an image display apparatus according to the present invention.

FIGS. 3A and 3B are schematic cross-sectional views for illustration of second resistive elements.

FIG. 4 is a schematic plan view of a face plate including third resistive elements.

FIGS. 5A, 5B and 5C are schematic plan views each illustrating a first resistive element.

FIG. 6 is a schematic plan view of second resistive elements.

FIG. 7 is a schematic plan view of third resistive elements.

FIG. 8 illustrates an equivalent circuit of a face plate according to the present invention.

FIG. 9 is a schematic diagram illustrating a potential difference occurring in a resistor member upon occurrence of a discharge.

FIG. 10 is a schematic diagram illustrating a cause of occurrence of streaking.

FIGS. 11A and 11B are schematic diagrams illustrating image quality deterioration resulting from streaking.

### DESCRIPTION OF THE EMBODIMENTS

Preferred embodiments of the present invention will now be described in detail in accordance with the accompanying drawings.

Hereinafter, an embodiment of the present invention will be described. An image display apparatus according to the present invention is applicable to a field electron emission display (FED) in which electron beams are provided from electron-emitting sources to form an image. In particular, it is favorable to apply the present invention to a flat FED in which a face plate and a rear plate are arranged close to each other and high electrical fields are applied therebetween because a discharge easily occurs and a discharge current easily increases in such a flat FED. A flat FED according to each of embodiments of the present invention will be described in details with reference to the drawings, taking a surface-conduction electron-emitter display (SED) apparatus from among the FEDs as an example.

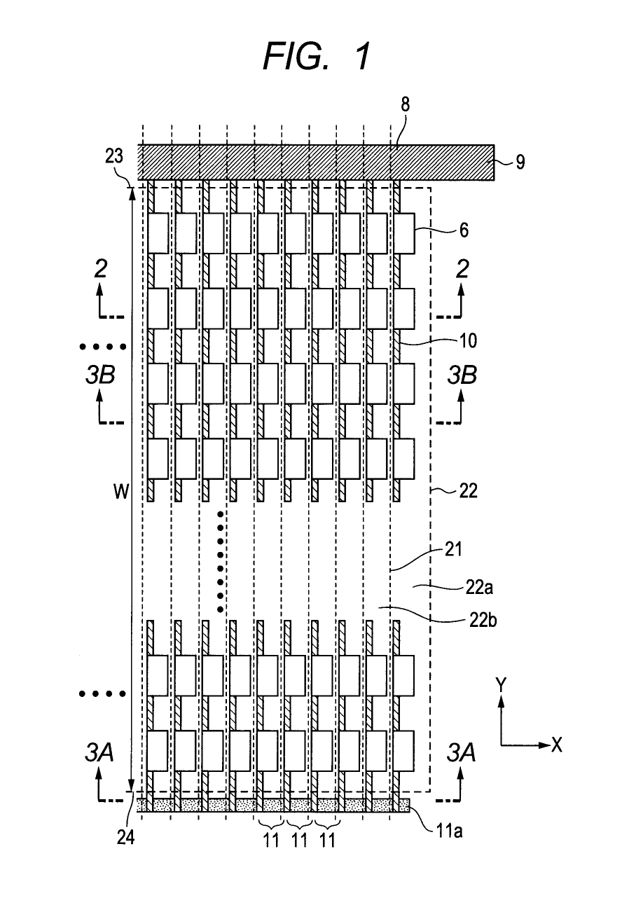

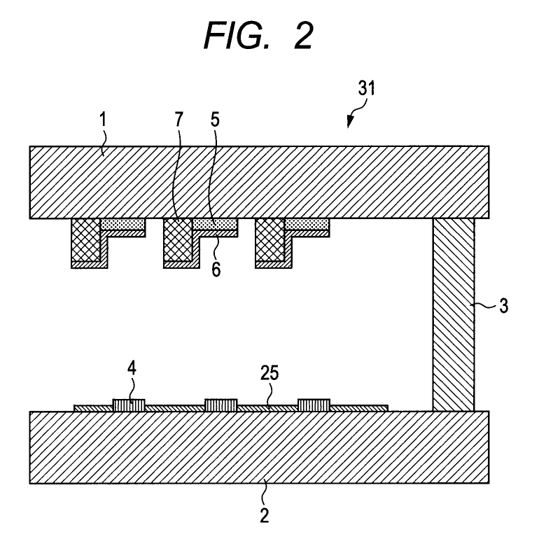

FIG. 1 is a schematic plan view of a face plate in an image display apparatus 31 according to the present invention. FIG. 2 is a schematic cross-sectional view of the image display apparatus according to the present invention taken along line 2-2 of FIG. 1. A vacuum-tight container is formed by a face plate 1, a rear plate 2 and side walls 3, and the inside of the container is depressurized and kept in a vacuum state.

A plurality of electron-emitting sources 4 are formed on the rear plate 2. Electron scanning lines 25 and non-illustrated signal lines are connected to the electron-emitting sources 4. Each electron-emitting source is driven by a line sequential driving method, and applies an electron beam to the face plate 2. In the case of the line sequential driving method, the scanning lines 25, one of which is illustrated in FIG. 2, are sequentially driven. Between the face plate 1 and the rear plate 2, non-illustrated spacers may be arranged. Spacers are members that define a space between the face plate 1 and the rear plate 2, and columnar or plate-like members can be used for the spacers.

Next, the face plate 1, which is a feature of the present invention, will be described in further details. The face plate 1 includes a rectangular image region 22 in which an image is displayed. The image region 22 includes divisional regions 22a, 22b, . . . resulting from dividing the image region 22 into n regions by n−1 imaginary lines (here, n is a natural number of no less than 2) perpendicular to one side 23 of the image region. FIG. 1 illustrates only a part of the image region 22, not all the divisional regions. Each of the divisional regions 22a, 22b . . . includes a plurality of light emitting members (phosphors 5) that emit light responsive to collision with electrons emitted from the electron-emitting sources 4 and accelerated, and a plurality of anodes 6 for accelerating the electrons. The face plate 1 includes a glass substrate of, e.g., soda-lime glass, alkali-free glass or high strain point glass with alkaline components adjusted, for transmitting light emitted from the phosphors 5.

The phosphors 5 are formed by applying a phosphor material to the face plate. The phosphor material emits light upon electrons are applied to the phosphor material.

Although the phosphors 5 are not illustrated in FIG. 1, the phosphors 5 are formed at positions that are substantially the same as the positions of the anodes 6, and as illustrated in FIG. 2, is covered by the anodes 6. For a material of the phosphors 5, a phosphor material that emits light upon being irradiated with an electron beam can be used. For provision of color display, P22 phosphors, which are used in the field of CRTs, can be used from the perspective of color reproducibility and brightness.

An anode 6, which is known in the field of CRTs, is formed on each phosphor 5. The anode 6 is provided to apply a desired acceleration voltage to the phosphor 5 and also to reflect light emitted from the phosphor 5 to increase the light extraction efficiency. For a material of the anodes 6, any material that reflects light and transmits an electron beam may be used, and aluminum, which exhibit good electron transmission property and light reflectivity, can be used.

Ribs 7 are formed for capturing reflected electrons generated in the phosphors 5 and the anodes 6. Examples of the shape of the ribs 7 include a straight shape or a waffle-like shape. When a color display is fabricated, ribs can be arranged between phosphors for respective RGB (red, green and blue) colors in order to prevent color mixing caused by reflected electrons. For the material of the ribs 7, any material having a resistance sufficiently higher than that of first resistor members 10, which will be describe later, and a strength resistant to destruction even where spacers are arranged. A material obtained by sintering a glass frit or a paste containing, e.g., insulating powder such as alumina and a glass frit can be used.

Next, the first resistor members 10 arranged for power supply will be described. In the face plate 1, power supply lines are formed by electrodes or resistive elements in order to supply power to the phosphors 5 and the anodes 6 in the image region 22. Where the power supply lines have a low resistance value, a large discharge current flows due to charge accumulated in an electrostatic capacitance between the face plate 1 and the rear plate 2 upon occurrence of a discharge. Accordingly, in order to suppress the discharge current between the face plate 1 and the rear plate 2, the power supply lines can have a resistance value that is equal to or exceeding a certain degree, and the power supply lines can be formed by first resistor members 10 with a relatively high electric resistance.

However, it is unfavorable that the first resistor members 10 have an excessively high resistance value because the first resistor members 10 allow the currents of electronic beams incident on the anodes 6 to flow therein. Therefore, there is a range of resistance values favorable for the first resistor members 10. For a material for the first resistor members 10, there are no specific limitations as long as the material can provide a desired resistance value. A material such as ruthenium oxide, indium tin oxide (ITO) or antimony tin oxide (ATO), whose resistance value can easily be controlled, can be used.

Examples of a configuration of the first resistor members 10 include a divided structure that is electrically divided in one direction, and a divided structure that is divided in a grid (two dimensions). Where straight ribs are arranged, the first resistor members 10 can be arranged on the ribs, facilitating fabrication of a structure that is electrically divided in one direction. In the present embodiment, a structure that is electrically divided in one direction is employed. N first resistor members 10 are provided and connected to a common electrode 8. The first resistor members 10 extend across the image region 22 in a direction perpendicular to a side 23, and are connected to the respective anodes 6 in the corresponding divisional regions 22a, 22b.

Where the first resistor members 10 with a structure that is electrically divided in one direction is arranged, it is desirable that the direction in which the first resistor members 10 extend across the image region 22 (Y direction in FIG. 1) be perpendicular to the scanning lines 25 (see FIG. 2), which are driven in a line sequential driving method. The scanning lines 25 extend in an X direction in FIG. 1. In the case of an FED that is driven by a line sequential drive method, the electron-emitting sources 4 on the scanning lines 25 are driven simultaneously with the scanning lines 25. Where the first resistor members 10 extend in parallel to the scanning lines 25, more emitted currents simultaneously flow into one first resistor member 10. Consequently, a large voltage drop occurs in a route in which the emitted currents flow into a high voltage source, resulting in image darkening. Arrangement of the first resistor members 10 in the direction perpendicular to the scanning lines 25, fewer emitted currents simultaneously flow into one first resistor member 10, allowing a decrease in voltage drop.

On the face plate 1, the common electrode 8, which extends along the side 23 of the image region 22 outside of the image region 22 and is supplied with power from the high voltage source (not-illustrated). The first resistor members 10, which are connected to the common electrode 8, are arranged in a direction perpendicular to the common electrode 8. The common electrode 8 is connected to the high voltage source via a high-voltage introduction section 9. Typically, the common electrode 8 can be arranged along a side of the image region 22, and have a length substantially equal to the side of the image region 22. The common electrode 8 includes a low-resistance material so that almost no voltage drop attributable to currents provided by electron beams occurs practically. For a material of the common electrode 8, a metal thin film or a sintered material of a paste containing metal powder can be used, and a material obtained by sintering a paste containing silver powder, a glass frit and a vehicle can be used because of its easiness of preparation.

Next, second resistor members 11, which form a feature of the present invention, will be described. The second resistor members 11 are arranged outside of the image region 22 along another side of the image region 22 opposite to the one side 23. In other words, the second resistor members 11 are arranged along a side 24, which is opposite to the side with which the common electrode 8 is arranged, across the image region 22. Each second resistor member 11 forms a part interconnecting two adjacent first resistor members 10. In FIG. 1, while the second resistor members 11 interconnect all the N first resistor members 10, and form one resistor member 11a as a whole, the individual second resistor members 11 form parts that interconnect two adjacent first resistor members 10.

The second resistor members 11 have a function that when a first resistive element 10 is disconnected at a position somewhere in the first resistive element 10, prevents a dark line from appearing as a result of no power being supplied to anodes 6 at positions further than the line disconnection part viewed from the common electrode 8. Accordingly, it is only necessary that the second resistor members 11 each connect one of the first resistor members 10 and another one of the first resistor members 10, and it is unnecessary that the second resistor members 11 form a successive element such as the resistor member 11a as a whole. The second resistor members 11 can be provided in such a manner that the second resistor members 11 are arranged for every other divisional region (in FIG. 1, the second resistor members 11 are deleted for every other divisional region). However, in order to prevent occurrence of a dark line, it is unfavorable that there is a first resistor member 10 not connected to another first resistor member 10, and it is desirable that each of all the first resistor members 10 be connected to at least one of the other first resistor members 10. It is also unfavorable to arbitrarily set a resistance value of the second resistor members 11, and there is a favorable resistance value range. The favorable resistance value range will be described later.

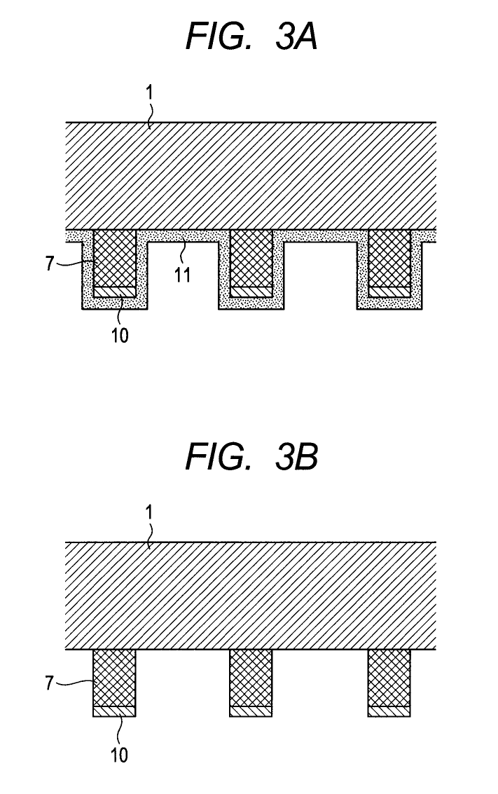

FIGS. 3A and 3B illustrate an arrangement of the second resistor members 11. FIG. 3A is a cross-sectional view taken along line 3A-3A of FIG. 1, and FIG. 3B is a cross-sectional view taken along line 3B-3B of FIG. 1. As illustrated in FIG. 3B, each first resistor member 10 is provided on a rib 7. In a part in which the first resistor member 10 is connected to a second resistor member 11, as illustrated in FIG. 3A, the first resistor member 10 is provided on a rib 7, and the second resistor member 11 is stacked on the first resistor member 10, thereby providing electrical connection between adjacent first resistor members 10. The method for electrical connection between the first resistor members 10 and the second resistor members 11 is not limited to this example, and for example, a configuration similar to that illustrated in FIG. 2 can be provided. More specifically, a structure in which a second resistor member 11 is arranged between two first resistor members 10 and the two first resistor members 10 and the second resistor member 11 are covered by a material similar to that of the anodes 6, thereby providing electrical connection, may be employed.

Although a material of the second resistor members 11 is not specifically limited as long as the second resistor members 11 have a desired resistance value, as with the first resistor members 10, a material such as ruthenium oxide, ITO or ATO can be used because of their easiness of resistance value control.

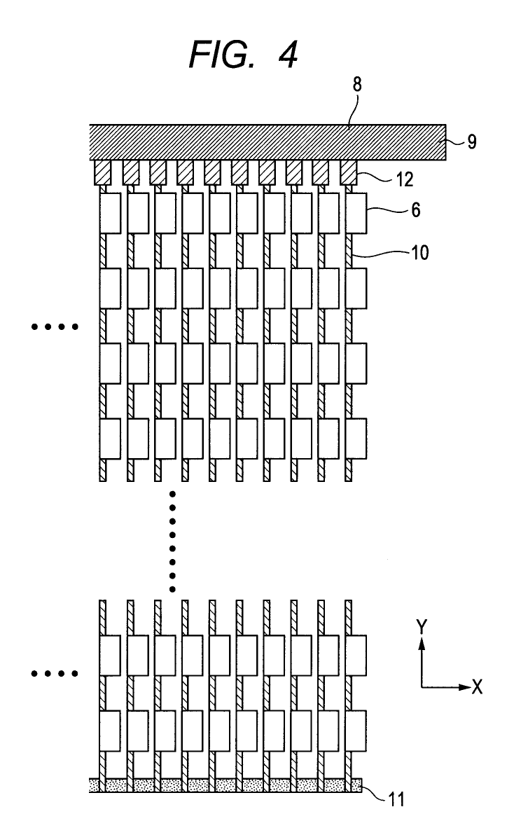

Another embodiment of the present invention will be described with reference to FIG. 4. FIG. 4 illustrates a structure in which third resistor members 12 are further arranged on the above-described face plate 1. The third resistor members 12 are provided to, when a discharge occurs in a site close to a common electrode 8 within an image region 22, prevent a large discharge current from flowing from the common electrode 8 into the image region 22. During an image being displayed, it is necessary to lessen a voltage drop caused by an emitted current to a certain degree, and accordingly, there is a favorable resistance value range. The favorable resistance value range will be described later.

Although a material of the third resistor members is not specifically limited as long as the third resistor members have a desired resistance value, as with first resistor members 10, a material such as ruthenium oxide, ITO or ATO can be used because of their easiness of resistance value control.

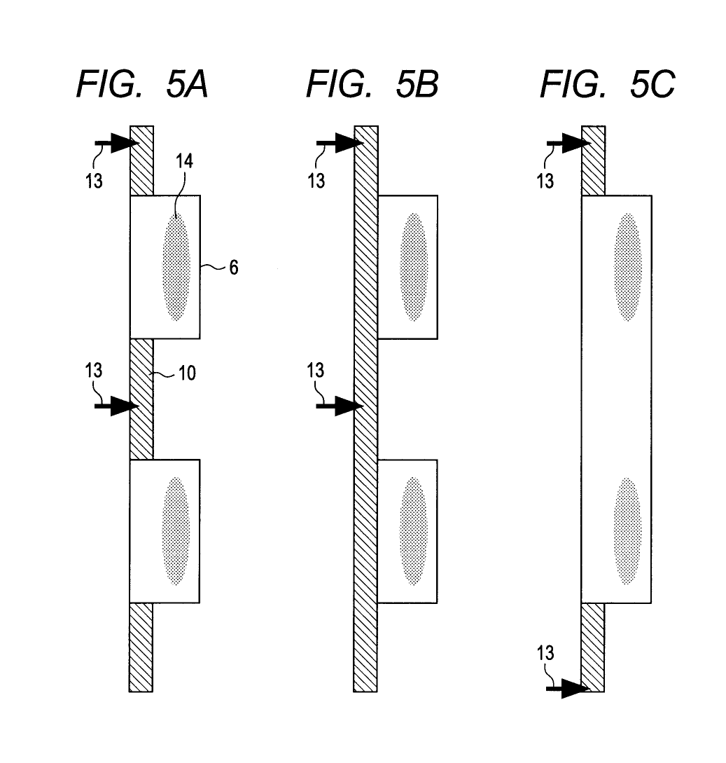

Next, definition of a resistance value R1 of each first resistor member 10, a resistance value (summed value) R1all of the first resistor members 10 within the image region 22, a resistance value R2 of each second resistor member 11 and a resistance value R3 of each third resistor member 12 will be described with reference to FIGS. 5A, 5B, 5C, 6 and 7.

FIGS. 5A, 5B and 5C each illustrate a first resistor member and anode formation method and definition of the resistance value R1. FIG. 5A illustrate a case where anodes 6 are formed on the first resistor members 10. FIG. 5B illustrates a case where anodes 6 are not stacked on the first resistor members 10 and power supply members (not illustrated) for the anodes 6 are separately provided. FIG. 5C illustrates a case where each anode 6 is arranged over two or more pixels. The respective Figures schematically illustrate ranges 14 each corresponding to one pixel. In the case of a color display, the range corresponding to one pixel can include three light emitting members for RGB, and in the case of a black-and-white display, can include one light emitting member. In other words, one pixel includes at least one light emitting member.

In the case of FIGS. 5A and 5B, the anodes 6 or the power supply members include a low-resistance thin film, and thus, the resistance value R1 of each first resistor member 10 is substantially determined by a shape of a part of the first resistor member 10 in which the anodes 6 are not arranged. In the case of FIG. 5C, it is difficult to obtain the resistance value R1 simply from the shape of the first resistor members 10. Therefore, the resistance value R1 of the first resistor member 10 is defined as a resistance value per reference length. It is assumed that the resistance value per reference length is an average resistance value per length of one pixel. The average resistance value is calculated by averaging a resistance value of a part between resistance measurement points 13 in the Figure so as to obtain a resistance value per pixel. In the case of FIGS. 5A and 5B, the resistance value of a part between the resistance measurement points 13 is a resistance value per reference length. In the case of FIG. 5C, the resistance value is not constant between pixels, and thus, resistance value measurement is conducted according to a repetition pitch of the anodes 6 to calculate an average resistance value R1 per length of one pixel.

Next, the resistance value R1all of the resistance values R1 in the image region 22 will be described. The resistance value R1all is a resistance value for the entire length of each first resistor member 10 in the image region 22. As will be described later, resistances R1 can be considered as being connected in series in one direction in the image region 22. The resistance value R1 is a resistance value per pixel, and thus, where a pixel count is N, the resistance value R1all for a width W of the image region can be expressed by R1all=R1×N. The resistance value substantially corresponds to a resistance value of a part from a pixel most distant from the common electrode 8 to the high voltage source.

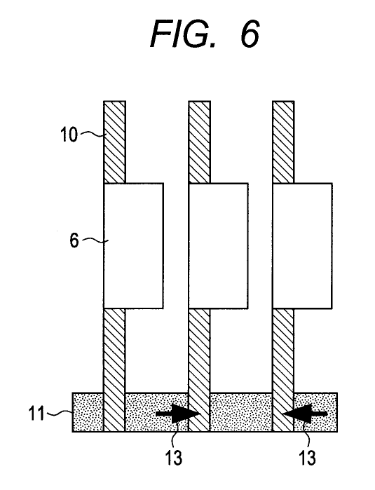

Next, the resistance value R2 of each second resistor member 11 will be described. The resistance value R2 can be expressed by a resistance value of a part between two electrically-connected first resistor members 10, and is defined as a resistance value of a part between resistance measurement points 13 illustrated in FIG. 6. Where three or more first resistor members 10 are interconnected, a plurality of resistance values for parts between the first resistor members 10 exist according to the number of the first resistor members 10. In such case, a smallest resistance value is defined as the resistance value R2.

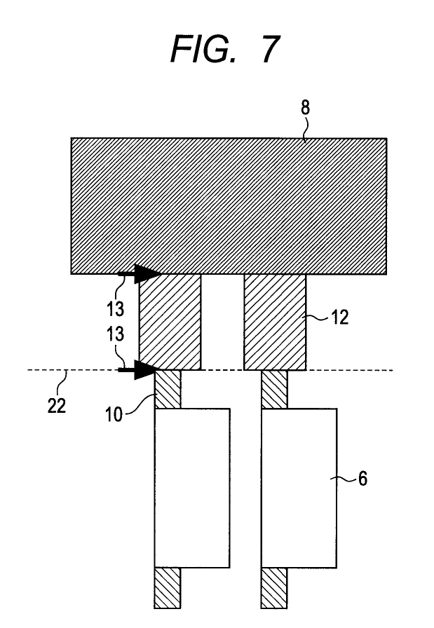

Next, the resistance value R3 of each third resistor member 12 will be described. The resistance value R3 is a resistance value of a part between the common electrode 8 and a first resistor member 10, and more specifically, a resistance value of a part between the common electrode 8 and an edge portion of the image region 22. The resistance value R3 is defined as a resistance value of a part between resistance measurement points 13 illustrated in FIG. 7.

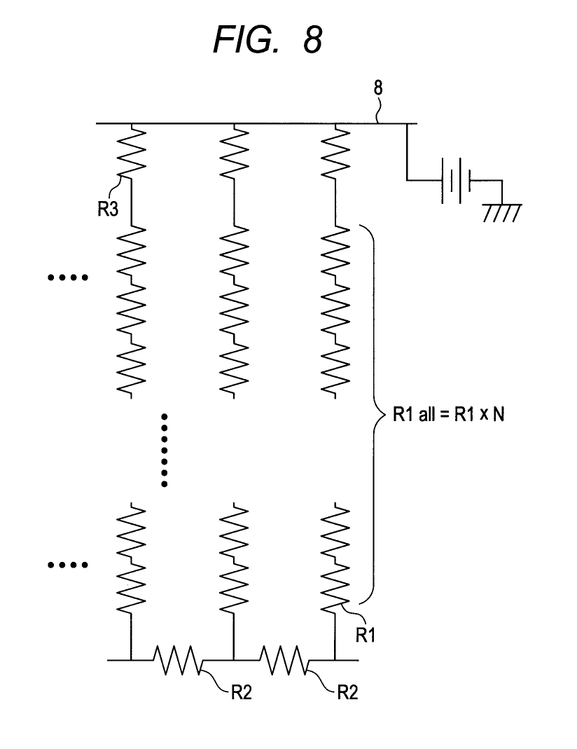

Next, a relationship between the resistance values of the respective resistor members, which are features of the present invention, will be described in further details with reference to the equivalent circuits illustrated in FIGS. 8, 9 and 10.

Favorable R1 Range

FIG. 8 illustrates an equivalent circuit diagram of a face plate according to the present invention. The resistance value R1 is determined in consideration of suppressing a discharge current upon occurrence of a discharge, and reducing a voltage drop caused by an emitted current upon an image being displayed. The value is determined by, e.g., the pixel size, the distance between the face plate 1 and the rear plate 2, an anode voltage and/or the emitted current amount. A range of around several ohms to several hundreds of megohms is favorable for the resistance value.

Favorable R2 Range

It is desirable that the resistance value R2 be determined in consideration of dark line suppression and discharge current suppression for their maximum values and streaking suppression for its minimum value.

Where line disconnection occurs at a position somewhere in a first resistor member 10, it is necessary to supply power to anodes 6 further than the line disconnection part viewed from the common electrode 8, so as to prevent occurrence of a dark line. The part of the first resistor member 10 that is further than the line disconnection part is connected to the common electrode 8 by a resistance R1all of another first resistor member 10 connected to the first resistor member 10 via the corresponding second resistor member 11 and a serial resistance formed by the first resistor member 10 and a resistance R2 of the second resistor member 11. If the resistance R2 has a value extremely much higher than that of the resistance R1all, the serial resistance value becomes too large, disabling sufficient power supply. As a result of diligent study, the inventors have discovered that where the resistance R2 is made to have a value smaller than that of the resistance R1all (R2<R1all), even when line disconnection occurs in the resistance R1, a brightness decrease caused by a voltage drop of each pixel further than the line disconnection part viewed from the common electrode 8 fall within a tolerable range.

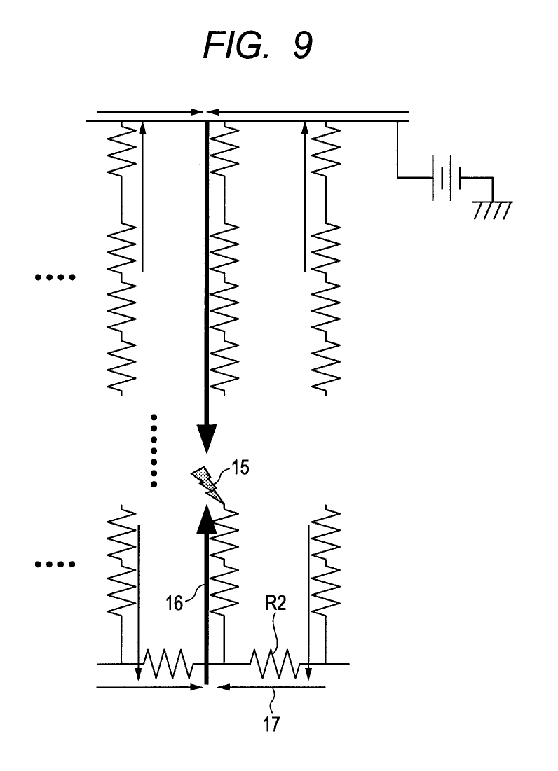

Next, a potential difference occurring in a resistance R2 as a result of a voltage drop upon occurrence of a discharge will be described with reference to FIG. 9. Upon occurrence of a discharge 15 in the image region, charge accumulated between the face plate 1 and the rear plate 2 flows into the image region through surface of the face plate 1 as discharge currents 16 and 17, and finally, the discharge currents 16 and 17 flow onto the rear plate 2. Here, if R1all<<R2, only the resistance R2 suppresses the discharge currents, increasing a potential difference occurring in the resistance R2 upon the occurrence of the discharge, resulting in destruction of the relevant second resistor member 11 and an increase in the discharge currents. As a result of diligent study, the inventors have discovered that making the resistance R2 have a value smaller than that of the resistance R1all (R2<R1all) enables suppression of a potential difference occurring in the relevant second resistor member 11 to be sufficiently small upon occurrence of a discharge, preventing destruction of the second resistor member 11 and an increase in the discharge current.

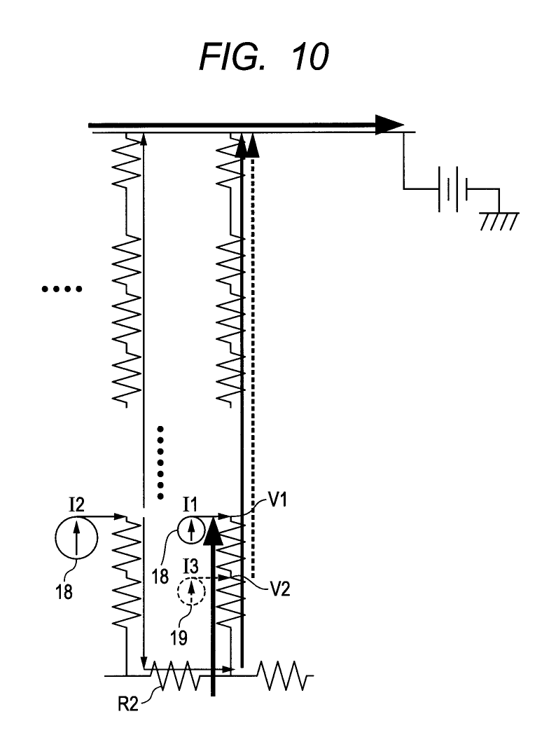

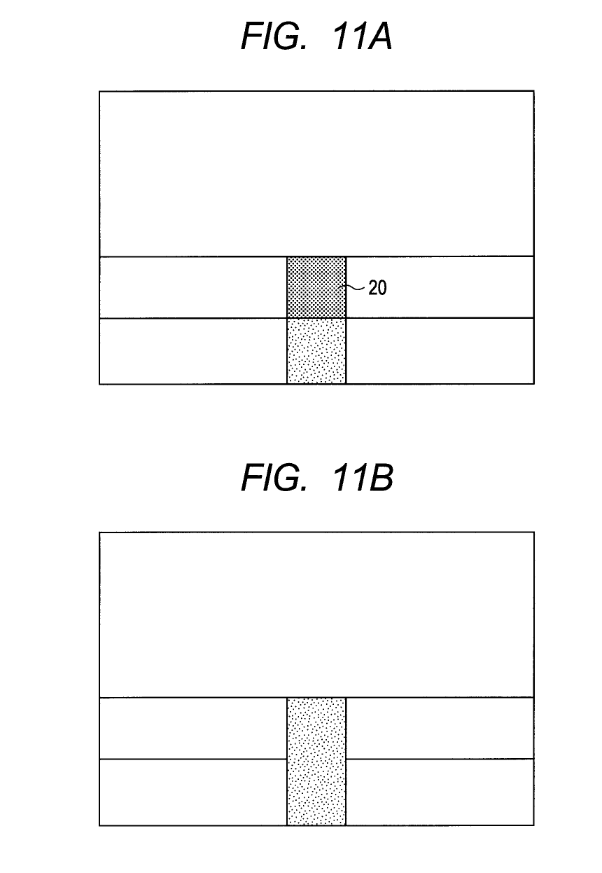

It is desirable that a minimum value of the resistance R2 is determined from the perspective of prevention of streaking. Image deterioration occurring when the resistance R2 is excessively low will be described with reference to FIGS. 10 and 11. FIG. 10 illustrates an equivalent circuit during driving. FIGS. 11A and 11B are schematic diagrams illustrating image quality deterioration called streaking: FIG. 11A illustrates a state of a screen when streaking occurs; and FIG. 11B illustrate a state of a screen when normal display without streaking is provided. As illustrated in FIG. 10, two current sources I1 and I2 are simultaneously driven to generate emitted currents 18 from the rear plate 2. As can be seen from the image figures in FIGS. 11A and 11B, the emitted current 18 from the current source I2 is made to be larger than the emitted current 18 from the emitted current I1. A current source 13 is driven at a timing different from that of the current sources I1 and I2 to generate an emitted current 19 (line sequential driving).

Voltages V1 and V2 at the positions illustrated in FIG. 10 will be described. When the current sources I1 and I2 are driven, the voltage V1 is subject to a voltage drop caused by a current flowing into the position of the voltage V1 from the current source I2 via the resistance R2 in addition to a voltage drop caused by a current flowing into the position of the voltage V1 from the current source I1. Meanwhile, when the current source I3 is driven, the voltage V2 is subject to a voltage drop caused by a current flowing from the current source I3 alone. Accordingly, even though the positions of V1 and V2 are driven so as to provide a same degree of brightness, if the resistance R2 has a large value, the voltage drop caused by a current from the current source I2 is also large. As a result, as illustrated in FIG. 11A, unevenness 20 in brightness occurs in an image, giving an obstacle in the image (streaking). If the resistance R2 has a small value, as illustrated in FIG. 11B, no unevenness in brightness occurs or only unnoticeable unevenness in brightness occurs.

As a result of diligent study of the relationship between the resistances R1 and R2, and streaking, the inventors have discovered that provision of a relationship of 0.1×R1<R2 enables a brightness difference due to streaking to be sufficiently small.

Next, a favorable R3 range will be described. It is desirable that the relationship between the resistance values R1 and R3 be determined in consideration of suppression of discharge currents and suppression of voltage drops caused by emitted currents. Upon occurrence of a discharge at a position close to the common electrode 8, a discharge current may flow into the image region 22 through the common electrode 8. Since the third resistor members 12 are provided to prevent such discharge current from flowing into the image region 22 to the extent possible, favorably, the resistance value R3 is larger than the resistance value R1 (R1<R3), and more favorably, is larger than a value ten times the resistance value R1. Furthermore, it is desirable that the amount of voltage drop caused by an emitted current be suppressed to the extent possible. Accordingly, making the resistance value R3 be smaller than the resistance value R1all (R3<R1all) enables the amount of voltage drop at the resistance R3 to be smaller than the amount of voltage drop in the image region 22.

For the relationship between the resistance values R2 and R3, each third resistor member 12, which is adjacent to the common electrode 8, is required to have a discharge current suppression function higher than that of each second resistor member 11. This is because comparing a case where a discharge occurs on the common electrode 8 side of the image region 22 and a case where a discharge occurs on the second resistor member 11 side of the image region 22, a discharge current occurring on the common electrode 8 side easily increases because the common electrode 8 has a low resistance value. Accordingly, it is favorable to make the resistance value R3 be larger than the resistance value R2 (R3>R2).

### Example 1

A face plate with the configuration illustrated in FIG. 1 was fabricated according to the process described below. An X direction and a Y direction in the following description are those illustrated in FIG. 1.

A glass substrate with a thickness of 2.8 mm (PD200 manufactured by Asahi Glass Co., Ltd.) as a substrate for the face plate 1, and a light-shielding layer (NP-7803D manufactured by Noritake Kizai Co., Ltd.) was formed on the glass substrate. Next, ribs 7 are formed by a photolithographic method, and phosphors 5 for RGB were applied between the ribs 7 and subjected to firing. Subsequently, an island-shaped anode layer 6 was formed on the phosphors 5 by a vacuum vapor deposition method. Finally, first resistive elements 10 and second resistive elements 11 were formed in this order by a photolithographic method, respectively. The pixel pitch was 900 μm and the width in the X direction of each of RGB was 300 μm. The number of pixels are 100×100 pixels, i.e., 300×100 in sub-pixels.

In the present example, Al was used for the anode layer 6, and the dimensions of the anode layer 6 for each pixel was 200 μm in the X direction and 450 μm in the Y direction. Each of the ribs 7 was formed so as to have a width of 50 μm, a length of 900 mm and a height of 200 μm, using an insulating member with a volume resistance of 100 kΩ·m. For the first resistor members 10, a resistive member with a volume resistance of 1.0 Ω·m was used. Since each first resistor member 10 is formed on an extremity of the corresponding rib 7, the first resistor member 10 was formed so as to have a width of 50 μm, a length of 900 mm, which are the same as those of the ribs 7, and a film thickness of 10 μm. Since the parts of the first resistor member on which anodes 6 are stacked have a low resistance, the length of the first resistor member that substantially acts as a resistive element is 450 μm. Each of the second resistor members 11 was formed so as to have a width of 700 μm, a length of 650 μm (including the lengths of side walls of ribs 7) and a thickness of 10 μm, using a resistive member with a volume resistance of 1.0 Ω·m as with the first resistive elements 10.

As a result of the first resistor members 10 and the second resistor members 11 being formed as described above, each first resistor member 10 had a resistance value of 900 kΩ and each second resistor member 11 had a resistance value of 93 kΩ. Accordingly, each second resistor member 11 had a resistance value higher than a value that is one-tenth of that of the first resistor members 11. The resistance value R1all, which is a sum of resistance values R1 in the image region was 90 MΩ, which was sufficiently larger than the resistance value R2.

When an image display apparatus using this face plate was fabricated and subjected to a discharge endurance test in a state in which the degree of vacuum of the inside of the apparatus had been deteriorated, it was confirmed that a current flowing upon occurrence of a discharge was reduced. Furthermore, no point defect occurred at the position where the discharge occurred, and the state of the apparatus before the occurrence of the discharge was maintained. When the image display apparatus was driven with a first resistor member 10 partially damaged, no line defect (dark line) occurs at a part of the first resistor member 10 beyond the damaged part, and no problem was visually confirmed. When the image display apparatus was driven to display a predetermined image figure and a brightness difference in the figure was measured, the brightness difference was not more than 1%, and thus, no problem was visually confirmed.

### Example 2

A face plate with the configuration illustrated in FIG. 4 was fabricated by the following process. An X direction and a Y direction in the below description correspond to those illustrated in FIG. 4.

A black paste (containing a black pigment and a glass frit) was subjected to screen printing on a surface of a cleansed glass substrate (PD200 manufactured by Asahi Glass Co., Ltd.) with a thickness of 1.8 mm so as to form a pattern of openings in a matrix on the substrate. In the opening pattern, the size of each opening has 150 μm (X direction)×300 μm (Y direction), the X-direction pitch of the openings was 200 μm, the Y-direction pitch of the openings was 600 μm, and openings corresponding to 300 sub-pixels in the X direction and 100 sub-pixels in the Y direction were formed. The substrate was dried at 120° C., and then fired at 550° C. to form a black matrix with a thickness of 5 μm (not illustrated).

Next, a plurality of ribs 7 were formed in stripes. A photosensitive insulating paste fabricated using alumina powder, a glass frit and a photosensitive paste was formed on the black matrix by a slit coater. Subsequently, the black matrix was patterned by means of photolithography and fired at 550° C. After the firing, each rib had a width of 50 μm and a height of 100 μm.

Next, a common electrode 8 was formed. A low resistance paste containing silver powder and a frit glass was subjected to screen printing to form a pattern with a width of 300 μm for a common electrode 8 and a high-voltage introduction section 9. Subsequently, the paste was dried at 120° C. for ten minutes to form a part corresponding to the common electrode 8 and the high-voltage introduction section 9. The common electrode 8 was formed so as to have a cross-sectional shape similar to that of the second resistor member 11 illustrated in FIG. 3A so that the common electrode 8 crosses over the ribs 7. When the paste was fired at 500° C. without the below described process steps, the resistance value measured for a length of 600 μm of the resulting paste was 30 mΩ.

Next, first resistor members 10 were formed in the pattern illustrated in FIG. 4. A high-resistance paste containing ruthenium oxide was provided on the ribs 7 by means of screen printing so as to provide a line width of 50 μm and a film thickness of 10 μm after firing, and then dried at 120° C. for ten minutes, thereby forming parts corresponding to first resistor members 10. The volume resistivity of the high-resistance paste after firing was 1.0 (Ω·m).

Next, second resistor members 11 were formed. A high-resistance paste containing ruthenium oxide, which had been adjusted so as to have a same degree of resistance as that of the first resistor members 10 is subjected to screen printing to form a pattern with a width of 300 μm, and then dried at 120° C. for ten minutes, thereby forming parts corresponding to second resistor members 11. The volume resistivity of the high-resistance paste after firing was 1.0 (Ω·m).

Next, third resistor members 12 were formed so as to have the pattern illustrated in FIG. 4. A high-resistance paste containing ruthenium oxide, which had been adjusted to provide a resistance higher than the common electrode 8, was subjected to screen printing to form patterns each having a width of 50 μm and a length of 1 mm and then dried at 120° C. for ten minutes, thereby forming parts corresponding to third resistor members 12. The volume resistivity of the high-resistance paste after firing was 5.0 (Ω·m).

Next, phosphors 5 were formed. The phosphors 5 were formed in the openings of the black matrix, which are arranged between the ribs 7, using phosphor pastes. For the phosphors, P22 phosphors (Y₂O₂S:Eu for red, ZnS:Ag, Al for blue, and ZnS:Cu, Al for green) were used. The phosphor pastes were provided at desired positions by means of screen printing and dried at 120° C.

Next, anodes 6 are formed. An intermediate film was formed by means of filming using an acrylic emulsion, which is known in the field of CRTs, and then, an Al film with a thickness of 0.1 μm for anodes was formed by means of a vacuum vapor deposition method using a metal mask. Subsequently, the film was fired at 450° C. to thermally decompose the intermediate film, thereby forming anodes 6. The anodes 6 were formed so as to cover the black matrix, and the width in the Y direction of each anode 6 overlapping with the corresponding first resistor member was 150 μm. Accordingly, each first resistor member formed on the corresponding anode had a length of 150 μm, a width of 50 μm and a thickness of 10 μm.

When the resistance values of the respective parts of the face plate after firing were measured, R1=30 kΩ, R1all=30 MΩ, R2=10 kΩ and R3=10 MΩ.

When an image display apparatus using this face plate was fabricated and subjected to a discharge endurance test in a state in which the vacuum of the inside of the apparatus had been deteriorated, it was confirmed that a current flowing upon occurrence of a discharge was reduced. Furthermore, no point defect occurred at the position where the discharge occurred, and the state of the apparatus before the occurrence of the discharge was maintained. When the image display apparatus was driven with a first resistor member 10 partially damaged, no line defect (dark line) occurs at a part of the first resistor member 10 beyond the damaged part, and no problem was visually confirmed. When the image display apparatus was driven to display a predetermined image pattern and a brightness difference in the figure was measured, the brightness difference was not more than 1%, and thus, no problem was visually confirmed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-158618, filed Jul. 13, 2010, which is hereby incorporated by reference herein in its entirety.

What is claimed is:

1. An image display apparatus comprising:
a rear plate wherein a plurality of electron-emitting sources are formed; and
a face plate provided with an image region of rectangular shape on which an image is displayed, wherein the image region is divided into n divisional regions by n−1 imaginary lines perpendicular to a one side of the image region, n is a natural number of 2 or more, and each of the divisional region includes a plurality of light emitting member emitting light responsive to a collision with an electron emitted from the electron source and accelerated and a plurality of anode for accelerating the electron,
wherein the face plate has a common electrode extending in an outside of the image region along the one side of the image region and supplied with an electricity from a high voltage source, n first resistor members connected to the common electrode, being extended across the image region in a direction perpendicular to the one side of the image region and being connected to each of the anodes of the divisional region corresponding thereto, and a second resistor member arranged in the outside of the image region along the other side of the image region opposite to the one side for connecting one of the first resistor members to the other one of the first resistor members, and wherein
R1 is an average resistance value of the first resistor member per a length of one pixel formed by at least one of the light emitting member, R1all is a resistance value of the first resistor member of total length in the image region, R₂ is a resistance value of the second resistor member, and a relation 0.1×R1<R2<R1all is met.

2. The image display apparatus according to claim 1, wherein
the image display apparatus is driven in a line sequential manner, and the direction of extending the first resistor member across the image region is perpendicular to a scanning line driven in the line sequential manner.

3. The image display apparatus according to claim 1, wherein
the face plate further has a third resistor member between the common electrode and the first resistor member, R3 is an average resistance value of the third resistor member, and a relation R1<R3<R1all is met.

4. The image display apparatus according to claim 3, wherein
a relation R3>R2 is met.
